(19) United States
(12) Patent Application Publication
(10) Pub. No.: US 2006/0026955 A1
(43) Pub. Date: Feb. 9, 2006

(54) Pressure-medium-actuated actuation device, in particular for a vehicle steering apparatus

(76) Inventor: Rolf Bogelein, Crailsheim (DE)

Correspondence Address: EDWARDS & ANGELL, LLP, P.O. BOX 55874, BOSTON, MA, 02205, US

(21) Appl. No.: 11/154,917

(22) Filed: Jun. 16, 2005

(30) Foreign Application Priority Data
Jun. 18, 2004 (DE) 10 2004 029 409.7

(51) Int. Cl. F16D 31/02

(52) U.S. Cl. 60/464

(57) ABSTRACT

A pressure-medium-actuated actuation device, in particular for a vehicle steering apparatus, comprises a double-acting actuator (12) with two active regions (24, 26) acting essentially in opposition, each active region (24, 26) having connected to it in each case a pressure-medium line section (28, 30), by means of which a pressure medium can be supplied to the active regions (24, 26) or can be discharged from these (24, 26), and each pressure-line section (28, 30) which supplies pressure medium to the actuator (12) being connected to a pressure-medium pump (14) coupled to a pump drive (16), by means of which the at least one pressure-medium pump (14) can be driven for the conveyance of pressure medium. According to the invention, the pump drive (16) is designed in such a way that the quantity of the pressure medium conveyed per unit time by the pressure-medium pump (14) can be varied and its conveying direction (I, II) can be reversed.

The present invention relates to a pressure-medium-actuated actuation device, in particular for a vehicle steering apparatus, comprising a double-acting actuator with two active regions acting essentially in opposition, each active region having connected to it in each case a pressure-medium line section, by means of which a pressure medium can be supplied to the active regions or can be discharged from these, and each pressure-medium line section which supplies pressure medium to the actuator being connected to a pressure-medium pump coupled to a pump drive, by means of which the at least one pressure-medium pump can be driven for the conveyance of pressure medium.

Such pressure-medium-actuated actuation devices are known to be electrohydraulic actuation devices in what may be referred to as power-assisted or orbital steering systems. In this context, a hydraulic pump can, by means of a 3-position/2-way valve, selectively be connected to one of two active regions of the double-acting actuator or be separated completely from this. The hydraulic pump is driven constantly with high power by the pump drive. As a function of the selected position of the 3-position/2-way valve, a hydraulic pump present in the known power-assisted steering systems is connected to one of two active regions of the actuator for the supply of hydraulic fluid, whilst the other active region in each case is connected, for the discharge of hydraulic fluid from it, to a hydraulic fluid tank, or the hydraulic line sections to both active regions are shut off, whilst the hydraulic pump extracts hydraulic fluid from the hydraulic fluid tank and pumps it back into the latter solely by short-circuit operation.

The known actuation device has the disadvantage that, on the one hand, the pressure-medium pump is operated permanently on the high load, this having an adverse effect both on the energy consumption and on the useful service life of the pressure-medium pump and pump drive. Furthermore, the 3-position/2-way valve has to be adjusted as a function of a steering actuation, thus constituting an additional outlay in coordination terms and an additional potential fault source.

A further disadvantage of the known actuation device is that only an adjustment of the actuator at essentially always the same adjustment speed is possible. It may be desirable, however, to adjust the actuator at different adjustment speeds.

One object of the present invention, therefore, is, in general, to specify a pressure-medium-actuated actuation device of the type mentioned in the introduction, which, by simple means and with a simple construction, allows a safe and reliable adjustment to the actuator. Furthermore, the actuation device according to the invention is to have a long useful service life.

A further object of the present invention is to specify an actuation device of the type mentioned in the introduction, in which the actuator can be adjusted at different speeds.

The abovementioned objects are achieved, in general, by means of a generic actuation device, in which the pump drive is designed in such a way that the quantity of the pressure medium conveyed per unit time by the pressure-medium pump can be varied and its conveying direction can be reversed.

In the actuation device configured according to the invention, by virtue of the variability of the pressure medium conveyed per unit time by the pressure-medium pump, the adjustment speed of the actuator can be varied, since the latter can be acted upon with pressure medium more slowly or more quickly.

Owing to the reversibility of the conveying direction of the pressure-medium pump, pressure medium can be supplied to or extracted from each active region of the actuator in a controlled manner, so that a controlled adjustment of the actuator into its two adjustment directions can be executed. In the event of the non-actuation of the pump, the pressure level just prevailing in the active regions is maintained and the actuator is thus fixed in its instantaneous position. A valve, such as the 3-position/2-way valve of the prior art, which is to be switched as a function of a command input, such as, for example, a steering actuation, is no longer necessary in the actuation device according to the invention, and therefore the construction of the latter is simplified.

Furthermore, the pump drive is operated only when an actual adjustment of the actuator takes place. Idling or a hydraulic short circuit, as in the prior art, is thus avoided. The useful service life of the actuation device according to the invention is thereby increased.

The term “useful service life” is to be understood, in the context of the present invention, as meaning that fraction of the service life which is actually utilized for an actuation of the actuation device. The term “service life” designates the net operating time of the pressure-medium pump and of the pump drive, that is to say the time in which the pump drive drives the pressure-medium pump until the pressure-medium pump or the pump drive fails.

When it is stated, in this application, that a pressure-medium line section supplying pressure medium to the actuator is connected to a pressure-medium pump, this means that pressure medium can always theoretically be supplied to the actuator by the pressure-medium pump.

Even if the pressure-medium-actuated actuation device according to the invention is provided essentially for use as a hydraulic actuation device of a vehicle steering apparatus, it is nevertheless not to be ruled out that the actuation device is also employed elsewhere, for example for the height adjustment of a load-lifting appliance of a floor-level conveying vehicle, whether for the height adjustment of, for example, a lifting fork with respect to a fork-lift truck carrying the latter or for the relative adjustment of two elements of a fork-lift truck with respect to one another, in particular with regard to a telescopic fork-lift truck.

In principle, any desired pumps may be used as pressure-medium pump. Various types of pump drives may likewise be envisaged. Preferably, however, the pressure-medium pump is a rotating pump, since this can convey continuously. In such a case, the pump drive driving the pressure-medium pump is preferably a rotary drive of variable rotational speed and reversible direction of rotation, preferably an electric motor, which can be varied in its rotational speed and reversed in its direction of rotation substantially more simply than, for example, an internal combustion engine which may likewise basically be considered as a pump drive.

Furthermore, in principle, it is conceivable that each of the two active regions is assigned its own pressure-medium pump which in each case supplies pressure medium to or extracts from this active region. This leads, however, to a less advantageous large overall volume, weight and high production costs. In order to avoid these disadvantages, the pressure-medium-actuated actuation device is preferably constructed in such a way that it comprises exactly one pressure-medium pump which is designed for the conveyance of pressure medium in two directions, the pressure-medium pump being connected to a first active region of the actuator via a first pressure-medium line section and to a second active region of the actuator via a second pressure-medium line section.

The term “active region” of the actuator designates a region of the actuator in which the pressure force of pressure medium is converted or can be converted into a movement of an actuating member of the actuator.

Admittedly, seals are provided at the connection points of pressure-medium lines to appliances, such as, for example, the actuator or the pressure-medium pump. However, it can never entirely be ruled out that not inconsiderable quantities of pressure medium in time escape from a pressure-medium line arrangement. A leakage of pressure medium may occur by diffusion even through the pressure-medium line material. So that such a leakage of pressure medium cannot put the operation of the actuation device at risk, there is provision, according to a development of the present invention, for a pressure-medium line arrangement connected to the actuator with pressure-medium transfer, preferably in each case the first and the second pressure-medium line section, to be connected to a pressure-medium reservoir via at least one pressure-medium extraction section, in particular with the interposition of at least one suction valve, preferably of one suction valve in each pressure-medium extraction section, the said suction valve allowing a flow of pressure medium out of the pressure-medium reservoir and shutting off a flow of pressure medium into the pressure-medium reservoir.

The suction valve serves for preventing a pneumatic or hydraulic short circuit with the pressure-medium reservoir and an accompanying undesirable pressure loss in the pressure-medium line arrangement.

As was already indicated in the introduction, the actuator can be held in a reached position by the pump being stopped. This may be sufficient for small loads in the actuator or the situations where the action of force on the actuator from outside is ruled out. As regards higher forces acting on the actuator from outside, however, a reaction on the pressure-medium pump cannot be ruled out under certain circumstances, and therefore the pump is driven in the overrun mode by the actuator, thus again allowing an undesirable adjustment of the actuator. This can be counteracted by providing the pump drive and/or the pressure-medium pump with a self-engaging brake or with a drive brake prestressed into a braking position. The brake may advantageously be configured in such a way that it is released in the event of the actuation of the pump drive, for example by means of a separate release device.

In principle, a separate pressure-medium line section may be provided in each case for the supply of pressure medium to the actuator and for the discharge of pressure medium from the actuator. In order, however, to prevent a complicated line routing and an unnecessarily complicated assembly, preferably the first and the second pressure-medium line section are designed both for the supply of pressure medium and for the discharge of pressure medium.

Alternatively or additionally to the abovementioned mechanical shut-off of the pump drive and/or of the pressure-medium pump, the actuator can be fixed in a desired position very simply and effectively in that a load-holding valve is provided in a pressure-medium line section between the pressure-medium pump and the assigned active region of the actuator, which load-holding valve can be switched between a normal position, in which it allows a flow of pressure medium in the direction of the actuator and shuts off the said flow in the opposite direction, and a load reduction position, in which it allows a flow of pressure medium in the direction away from the actuator. Through the provision of a load-holding valve of this type, although pressure medium can be supplied to the actuator, it cannot readily be discharged from the latter, so that an adjustment of the actuator counter to the active region in whose assigned pressure-medium line section the load-holding valve is provided is not possible. Such adjustment is possible only after the load-holding valve has been switched from the normal position to the load reduction position.

For an increased operating reliability, it is advantageous if the load-holding valve is prestressed into the normal position, since an undesirable adjustment of the actuator by an uncontrollable load or force acting on it from outside is then impeded or even ruled out.

Particularly preferably, a load-holding valve is provided both in the first and in the second pressure-medium line section, so that the actuator is fixed in both adjustment directions. It may also be desirable, however, to fix the actuator in only one adjustment direction, for example when the actuation device is used as a lift actuation device for the lifting of loads. In this case, it may be desirable that lifting is always to be possible, but the actuator is secured in the load-lowering direction by means of a load-holding valve.

In this case, the necessary adjustment of one the load-holding valve from the normal position into the load reduction position can take place in a simple way as a function of a pressure of the pressure medium which prevails in the pressure-medium line section having the other load-holding valve in each case. A control of the load-holding valve can thus be avoided, since the load-holding valves are installed in a self-controlling manner. When pressure medium is supplied to an active region, the pressure rises in the assigned pressure-medium line section. This increased pressure in the one pressure-medium line section serves as control pressure for adjusting the load-holding valve of the other pressure-medium line section in each case into the load reduction position and thereby for allowing an outflow of pressure medium from the other active region in each case. Preferably, the pressure in the direction of flow towards the actuator, upstream of the other load-holding valve in each case is used as control pressure, since this portion of the pressure-medium line section is, as a rule, acted upon with a lower pressure than the portion between load-holding valve and active region.

According to a preferred development of the invention, the actuation device can cooperate with a regulating device which activates the pump drive in such a way that the actuator is adjusted from an actual position towards a desired position until the actual and the desired position essentially coincide. In this case, however, an overshoot may occur, so that the actuator is adjusted, at a very high outlay in regulating terms, from a position adjusted beyond the actual desired position in the opposite direction back towards the desired position. Even during this correcting movement, an overshoot may again occur, and therefore the desired position of the actuator is reached only gradually and after a high outlay in terms of the actuation of the actuation device.

Such an outlay in terms of actuation and the time required for setting the desired position of the actuator can be reduced in that there is provided, in one, preferably in each pressure-medium line section designed for the discharge of pressure medium from an active region of the actuator, a counterpressure valve arrangement which shuts off a flow of pressure medium in the direction away from the actuator up to a predetermined clearance pressure of the pressure medium and, in the case of a pressure of the pressure medium exceeding this clearance pressure, allows a flow of pressure medium in the direction away from the actuator. This refinement ensures that the actuator always has to be adjusted counter to the predetermined clearance pressure as the minimum pressure, so that an overshoot of the actuator beyond its desired position is avoided or is at least greatly reduced in extent.

In the event of the first and the second pressure-medium line section being designed both for the supply of pressure medium and for the discharge of pressure medium, in the preferred development of the invention the counterpressure valve arrangement should allow a flow of pressure medium in the direction of the actuator. In a structural embodiment of the counterpressure valve arrangement, this can be achieved by means of a non-return valve and a cut-in valve connected in parallel to the latter. Preferably, a cut-in valve with an adjustable counterforce is selected, so that the clearance pressure can be freely predetermined. The “cut-in valve, is understood to mean a valve which clears a valve outlet counter to a preset or settable external force, as a rule a spring force.

As regards a pressure-medium actuated actuation device, the situation may be envisaged where, although the actuator is to be adjusted, it cannot be adjusted because of a physical obstacle. As a consequence of this, the pressure on the side of the active region to which pressure medium is to be supplied would rise sharply. So that an excessive pressure rise of this type can be avoided, at least one pressure-limiting valve can be provided, which is designed for limiting the pressure in a pressure-medium line section assigned to it, preferably in each pressure-medium line section, to a predetermined pressure-medium limit pressure.

According to a simple, but effective structural embodiment, the pressure in one, preferably in each pressure-medium line section can be limited in that the pressure-limiting valve allows a flow of pressure medium out of the pressure-medium line section assigned to it. In this case, pressure medium is simply discharged from the pressure-medium line section running the risk of excess pressure, and the pressure is thereby lowered. For this purpose, the pressure-limiting valve may be configured in such a way that it opens a pressure-medium bleed line when the pressure of the pressure medium in the pressure-medium line section assigned to it exceeds the predetermined pressure-medium limit pressure.

As was indicated above by the preferred embodiment with only exactly one pressure-medium pump, pressure medium is preferably pumped around in a closed system between the active regions of the actuator. This closed system, with particularly low pressure-medium loss, may be maintained even when there is at least one pressure-limiting valve, specifically when the at least one pressure-limiting valve is arranged in a pressure-medium connecting line connecting the first and the second pressure-medium line section. In this case, an opening of a pressure-limiting valve leads, because of excessive pressure in the pressure-medium line section assigned to it, to the opening of a connection to the other pressure-medium line section in each case and, consequently, to a pneumatic or hydraulic short circuit, thus sharply lowering the pressure in the pressure-medium line arrangement. In a preferred development of the invention, advantageously both pressure-medium line sections, the first and the second, are protected in the same way against excessive pressure, in that in each case a pressure-limiting valve assigned to the first and to the second pressure-medium line section is provided, each pressure-limiting valve allowing a flow of pressure medium away from one pressure-medium line section to the other pressure-medium line section in each case, when the pressure of the pressure medium in the respective pressure-medium line section exceeds the predetermined pressure-medium limit pressure.

In a structural embodiment, the at least one pressure-limiting valve may be a cut-in valve which keeps low the types of valves used in the pressure-medium-actuated actuation device of the present invention. Even less well-trained or less experienced personnel can therefore be employed or trained for maintenance and repair. So that the pressure limitation can be adapted to the pressure-medium line sections present in each case, a cut-in valve with an adjustable counterforce may preferably be used.

So that, after an adjustment of the actuator, the pump can be relieved of the pressure built up by it in a pressure-medium line section, at least one pressure-medium line section, preferably all pressure-medium line sections, may be connected to a pressure-medium reservoir via a throttle. The lifetime of the pump is thereby increased on account of the reduced load permanently acting on it.

The actuator may be a piston/cylinder system with two cylinder spaces which lie opposite one another with respect to the piston as actuating member and each cylinder space of which forms an active region. Should a continuously adjustable actuator be desired instead, an actuator capable of being driven in a rotational movement, for example a hydraulic motor, may be employed. In such a case, a supply of pressure medium to one active region causes a clockwise rotation of the actuator shaft, and a supply of pressure medium to the other active region in each case causes an anti-clockwise rotation.

The pressure medium of the actuation device may be a gas or a liquid. It is preferably a hydraulic fluid, since by means of this, on the one hand, higher loads can be adjusted by means of the actuator, and, moreover, the actuator responds more quickly to a pressure change by means of the pump.

As already indicated, the pressure-medium-actuated actuation device of the present invention may be employed for various tasks. It is preferably employed, however, in a steering apparatus with a wheel receptacle pivotable about a steering axis and with a force transmission device transmitting a steering force to the wheel receptacle, the force transmission device being designed in such a way that it transmits a force emitted by the actuator of the actuation device to the wheel receptacle in order to pivot the latter about the steering axis. Independent protection is sought for such a steering apparatus.

Since load lifting and lowering tasks can also be dealt with by means of the actuation device according to the invention, this actuation device is preferably installed in a floor-level conveying vehicle, particularly preferably in a lift truck. The actuation device according to the invention gives a floor-level conveying vehicle of this type an intrinsic value, and therefore independent protection is also sought for this. The same applies to the abovementioned steering apparatus.

The construction of the floor-level conveying vehicle can be substantially simplified, above all in terms of the steering, if it has a steering apparatus with an actuation device of the present invention. In this case, the steering may be implemented fully according to the “steer-by-wire” principle, that is to say a steering means, such as, for example, a steering wheel, steering stick or a steering horn and the like, serves merely as an input means in order to input a desired change in direction of the floor-level conveying vehicle to a steering regulation apparatus. By means of at least one steering-angle sensor, at least one quantity is detected which represents the instantaneous steering-angle position of at least one steerable wheel. This quantity may, for example, be an angle which is formed between a plane orthogonal to the wheel axis of the steerable wheel and a vehicle longitudinal mid-plane running in the longitudinal direction of the floor-level conveying vehicle and orthogonal to the roadway. Furthermore, by means of at least one steering-means sensor, at least one steering quantity representing an actuation of the steering means is detected. Where a steering wheel is concerned, this may be, for example, the angle of lock of the steering wheel and/or the speed of lock of the steering wheel and the like. Where other steering means are concerned, corresponding quantities are detected.

The steering regulation apparatus provided on the floor-level conveying vehicle is designed, furthermore, for determining, starting from the detected steering quantity, a desired steering quantity which represents a wanted steering-angle position (desired steering-angle position) of the at least one steerable wheel. Finally, the steering regulation apparatus is designed in such a way that it activates the pump drive in such a way that the at least one steerable wheel, starting from its instantaneous steering-angle position, is pivoted in the direction of the wanted steering-angle position. Pivoting lasts until the wanted steering-angle position is reached.

The present invention will be explained in more detail with reference to the accompanying FIGURE.

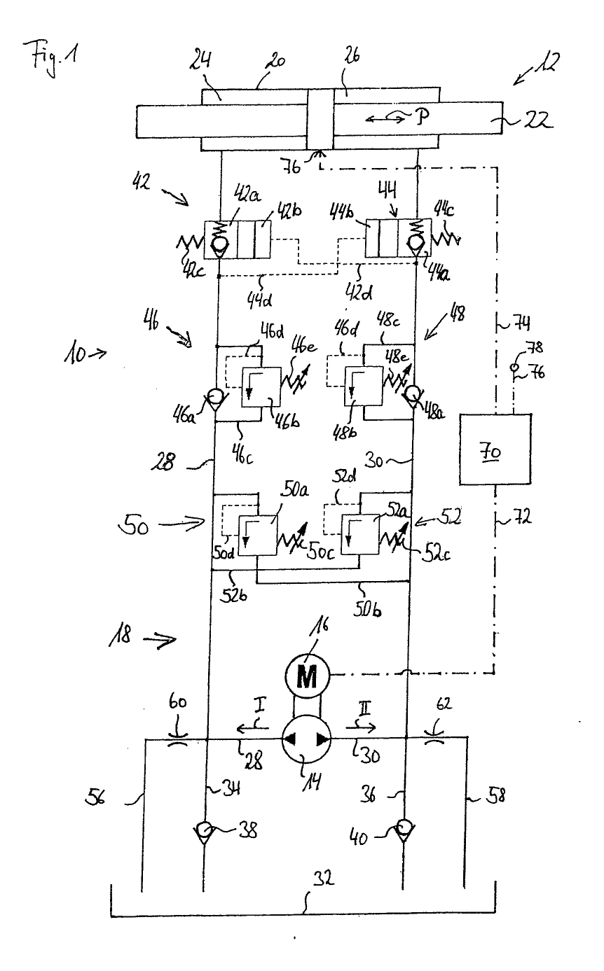

The accompanying FIGURE (FIG. 1) illustrates a preferred embodiment of the pressure-medium-actuated actuation device according to the invention.

In FIG. 1, an actuation device according to the invention is designated in general by 10. The actuation device 10 comprises a double-acting actuator 12 in the form of a piston/cylinder unit, a hydraulic pump 14, an electric motor 16 connected to the hydraulic pump 14, and a hydraulic line arrangement 18 connecting the pump 14 to the actuator 12.

The electric motor 16 is variable in its rotational speed and is reversible in its direction of rotation. Accordingly, a hydraulic pump 14 driven by it can convey hydraulic fluid in both directions, identified by the arrows I and II, at a different flow velocity substantially proportional to the rotational speed of the motor 14.

The actuator 12 comprises a cylinder 20 and a piston 22 received in the latter displaceably in the direction of the double arrow P. The actuator 12 has a first active region 24, which, when hydraulic fluid is supplied into the latter, causes a displacement of the piston 22 to the right in FIG. 1, and a second active region 26, which, when hydraulic fluid is supplied into the latter, causes a movement of the piston 22 to the left in FIG. 1. The first active region 24 is connected to the pump 14 by means of a first hydraulic line section 28. The second active region 26 is connected to the hydraulic pump 14 by means of a second hydraulic line section 30.

The first hydraulic line section 28 is connected via a hydraulic-fluid extraction secti on 34 to a hydraulic-fluid tank 32 which is illustrated in FIG. 1 merely diagrammatically and without the hydraulic fluid contained in it. The second hydraulic line section 30 is likewise connected to the hydraulic-fluid tank 32 via a second hydraulic-fluid extraction section 36. A suction valve 38 and 40 in the form of a non-return valve is provided in each case in the hydraulic-fluid extraction sections 34 and 36, in such a way that hydraulic fluid can flow only from the tank 32 to the hydraulic line sections 28 and 30, but not from these into the tank 32 via the sections 34 and 36.

In the first hydraulic line section 28, a first load-holding valve 42 is provided near the first active region 24 of the actuator 12. A second load-holding valve 44 of identical type of construction is likewise provided, near the second active region 26, in the second hydraulic line section 30. On account of the identical type of construction of the two load-holding valves 42 and 44, only the first load-holding valve 42 will be explained in more detail. The second load-holding valve 44 functions correspondingly. Identical functional parts of the second load-holding valve 44 are designated by the same reference symbols, but merely increased by the digit 2.

The first load-holding valve 42 is illustrated in FIG. 1 in its normal position in which it allows a flow of hydraulic fluid into the first active region 24, but shuts off a flow out of the first active region 24. This is achieved, in the example shown in FIG. 1, by means of a spring-prestressed non-return valve 42a. In a less preferred embodiment, a simple non-return valve without spring prestress may also be provided. A second passage section 42b can be set into the line string of the first hydraulic section 28 counter to the prestressing force of the spring 42c, so that hydraulic fluid can both flow into the first active region 24 and flow out of the latter.

To adjust the first load-holding valve 42 from the normal position illustrated into the load reduction position, in which the passage section 42b is active, a control line 42d is provided, which acts upon the first load-holding valve 42 with the pressure of the hydraulic fluid in the second hydraulic line section 30 counter to the force of the spring 42c. More precisely, the first load-holding valve 42 is acted upon with the pressure which prevails in the direction of flow towards the second active region 26, upstream of the second load-holding valve 44 in the second hydraulic line section 30. The advantage of this is that a weaker spring 42c is sufficient, since the portions upstream of the load-holding valves can be relieved of pressure, whilst the pressure in the section portions lying between the load-holding valves 42 and 44 and the actuator 12 is to be kept exactly at a high level.

If, then, the pressure in the second hydraulic line section 30 rises because the pump 14 pumps hydraulic fluid into the second active region 26 in order to displace the piston 22 to the left in FIG. 1, the control pressure in the control line 42d also rises, so that the first load-holding valve 42 is displaced to the left into the load reduction position counter to the force of the spring 42c. Hydraulic fluid can then flow through the first load-holding valve 42 out of the first active-region 24, so that a displacement of the piston 22 becomes possible.

Away from the actuator 12 in the direction of flow, and following the load-holding valves 42 and 44, a first counterpressure valve arrangement 46 is provided in the first hydraulic line section 28 and a second counterpressure valve arrangement 48 is provided in the second hydraulic line section 30. The first 46 and second 48 counterpressure valve arrangement are of identical construction, and therefore only the first counterpressure valve arrangement 46 is described below. The same functional elements as in the first counterpressure valve arrangement 46 are given the same reference symbols, but increased by the digit 2, in the second counterpressure valve arrangement 48.

The counterpressure valve arrangement 46 comprises a non-return valve 46a which is provided in the first hydraulic line section 28 and which is provided such that it allows a flow of hydraulic fluid to the actuator 12, but shuts off away from the latter.

A cut-in valve 46b is arranged in a line string 46c parallel to the non-return valve 46a which may also be spring-preloaded. Via a control line 46d, the pressure prevailing downstream of the non-return valve 46a in the first hydraulic line section 28 towards the actuator 12 in the direction of flow is exerted as control pressure on the cut-in valve 46b.

The cut-in valve 46b is prestressed by spring means 46e of adjustable force into a non-passage position. In a less preferred embodiment, the spring means 46e may even be non-adjustable and deliver a permanently predetermined force.

When the control pressure in the control line 46d becomes so high that the force exerted by it on the cut-in valve 46b becomes higher than a closing force exerted by the spring means 46e, the cut-in valve 46b is adjusted into a passage position, so that hydraulic fluid, bypassing the non-return valve 46a, can flow from the first active region 24 in the direction of the hydraulic-fluid tank 32. The provision of the counterpressure valve arrangements 46 and 48 ensures that hydraulic fluid can flow out of the active regions 24 and 26 solely so as to ensure a minimum counterpressure determined by the spring means 46e and 48e. This shortens the regulating time required for setting the piston 22 into a desired position, because it impedes or even prevents an overshooting of the piston beyond the desired position wanted.

In the first hydraulic line section 28, a first pressure-limiting device 50 is provided next to the hydraulic pump 14. In the second hydraulic line section 30, a second pressure-limiting device 52 is likewise provided next to the hydraulic pump 14. The first 50 and second 52 pressure-limiting device are structurally identical, and therefore only the first pressure-limiting device 50 will be described below. Identical functional units of the second pressure-limiting device 52 are given the same reference symbols as those of the first pressure-limiting device 50, but increased by the digit 2.

The first pressure-limiting device 50 comprises a cut-in valve 52a, as is already used in the counterpressure valve arrangements 46 and 48. The cut-in valve 52a is arranged in a line string 52b which connects the first hydraulic line section 28 to the second hydraulic line section 30. The cut-in valve 50a is prestressed by a spring means 50c into a non-passage position. A control line 50d supplies the hydraulic-fluid pressure prevailing in the first hydraulic line section 28 for the cut-in valve 50a in such a way that the said hydraulic-fluid pressure acts in the direction of an adjustment of the cut-in valve 50a to the passage position. The spring means 50c may also be chosen with a permanently selected counterforce, that is to say so as to be non-adjustable.

The prestressing force into the non-passage position, exerted on the cut-in valve 50a by the spring means 50c, should be selected such that, in the case of pressures usually occurring in the first hydraulic line section 28 during the normal operation of the actuation device 10, no adjustment of the cut-in valve 50a into the passage position takes place. If, however, for any reason, for example owing to a jamming of the actuator 12 or to an obstruction of the piston 22, during a desired adjustment of the latter the pressure in the first hydraulic line section 28 were to rise above a limit pressure defined by the spring means 50c, this pressure acts via the control line 50d on the cut-in valve 50a in such a way that the latter is adjusted into the passage position and therefore a hydraulic short circuit is made between the first and the second hydraulic line section 28 and 30. Hydraulic fluid is then merely pumped around in circulation, so that a further pressure rise is prevented.

When, after an adjustment of the piston 22, the actuator 12 is clamped in its reached position by means of the load-holding valves 42 and 44, the hydraulic pump 14 is normally switched off. Identical relief lines 56 and 58 are provided in order to increase the service life of the hydraulic line portions lying between the hydraulic pump 14 and the load-holding valves 42 and 44. The first relief line 56 connecting the first hydraulic line section 28 to the hydraulic-fluid tank 32 makes it possible, via a throttle valve 60, to have a gradual reduction of the pressure in that portion of the first hydraulic line section 28 which lies between the first load-holding valve 42 and the pressure-medium pump 14. The second relief line 58 likewise makes it possible to have a gradual pressure reduction in the corresponding portion of the second hydraulic line section 30 via the throttle valve 62.

The construction of the present actuation device may be further simplified in that the relief lines 56 and 58 are designed as bypass lines with respect to the suction valves 38 and 40 and the throttle valves 60 and 62 switch directly in parallel with the suction valves 38 and 40, as is the case in the counterpressure valve arrangements 46 and 48 of the example shown.

The actuator 12 shown in FIG. 1 may be part of a steering apparatus or of a load lifting and lowering apparatus. It may, furthermore, also be used for adjusting further elements in two essentially opposite directions, even directions of rotation.

FIG. 1 also illustrates a regulating device 70 which can activate the electric motor 16 via a control line 72 depicted by dashes and dots. The control line 72 in this case transmits switch-on and switch-off commands and also commands with regard to the rotational of speed and direction of rotation of the electric motor 16, the coupling of the motor 16 and hydraulic pump 14 being such that the quantity of hydraulic fluid conveyed per unit time by the hydraulic pump 14 is proportional to the rotational speed of the motor 16, and that, further, the conveying direction of the hydraulic pump 14 is dependent on the direction of rotation of the motor 16.

The regulating device 70 receives information on the instantaneous position of the piston 22 of the actuator 12 from a sensor 76 via an information line 74. Via a further information line 76, which is merely indicated in FIG. 1, the regulating device switches information from an input device 78, illustrated symbolically in FIG. 1. From the information of the input device 78, the regulating device 70 determines a desired position of the piston 22 and compares this desired position with the actual position obtained from the sensor 76. As a function of a comparison between the desired and the actual position, the motor 16 is driven by the regulating device 70 via the control line 72, in such a way that the piston 22, starting from the actual position, moves in the direction of the desired position. The drive is maintained until the piston 22 is in the desired position determined, if appropriate within a preset tolerance.

1. Pressure-medium-actuated actuation device, in particular for a vehicle steering apparatus, comprising a double-acting actuator with two active regions acting essentially in opposition, each active region having connected to it in each case a pressure-medium line section, by means of which a pressure medium can be supplied to the active regions or can be discharged from these, and each pressure-medium line section which supplies pressure medium to the actuator being connected to a pressure-medium pump coupled to a pump drive, by means of which the at least one pressure-medium pump can be driven for the conveyance of pressure medium, wherein the pump drive is designed in such a way that the quantity of the pressure medium conveyed per unit time by the pressure-medium pump can be varied and its conveying direction (I, II) can be reversed.

2. Pressure-medium-actuated actuation device according to claim 1, wherein the pressure-medium pump is a rotating pump, and in that the pump drive is a rotary drive of variable rotational speed and reversible direction of rotation, preferably an electric motor.

3. Pressure-medium-actuated actuation device according to claim 1, wherein the device comprises exactly one pressure-medium pump which is designed for the conveyance of pressure medium in two directions (I, II), the pressure-medium pump being connected to a first active region of the actuator via a first pressure-medium line section and to a second active region of the actuator via a second pressure-medium line section.

4. Pressure-medium-actuated actuation device according to claim 1, wherein a pressure-medium line arrangement connected to the actuator with pressure-medium transfer, preferably in each case the first and the second pressure-medium line section, is connected to a pressure-medium reservoir via at least one pressure-medium extraction section, in particular with the interposition of at least one suction valve, preferably of one suction valve in each pressure-medium extraction section, the said suction valve allowing a flow of pressure medium out of the pressure-medium reservoir and shutting off a flow of pressure medium into the pressure-medium reservoirs.

5. Pressure-medium-actuated actuation device according to claim 1, wherein the pump drive and/or the pressure-medium pump is provided with a self-engaging brake or with a drive brake prestressed into a braking position.

6. Pressure-medium-actuated actuation device according to claim 3, wherein the first and the second pressure-medium line section are designed both for the supply of pressure medium to the actuator and for the discharge of pressure medium from the said actuator.

7. Pressure-medium-actuated actuation device according to claim 6, wherein there is provided, in one, and preferably in each pressure-medium line section between the pressure-medium pump and the assigned active region of the actuator, a load-holding valve which can be switched between a normal position, in which it allows a flow of pressure medium in the direction of the actuator and shuts off the said flow in the opposite direction, and a load reduction position, in which it allows a flow of pressure medium in the direction away from the actuator, the load-holding valve preferably being prestressed into the normal position.

8. Pressure-medium-actuated actuation device according to claim 7, wherein a load-holding valve is provided in each case in each pressure-medium line section in such a way that the adjustment of one load-holding valve from the normal position into the load reduction position takes place as a function of a pressure of the pressure medium which prevails in the pressure-medium line section having the other load-holding valve in each case, preferably which prevails towards the actuator in the direction of flow, upstream of the other load-holding valve in each case.

9. Pressure-medium-actuated actuation device according to claim 1, wherein there is provided, in one, preferably in each pressure-medium line section designed for the discharge of pressure medium from an active region of the actuator, a counterpressure valve arrangement which shuts off a flow of pressure medium in the direction away from the actuator up to a predetermined clearance pressure of the pressure medium and, in the case of a pressure of the pressure medium exceeding this clearance pressure, allows a flow of pressure medium in the direction away from the actuators.

10. Pressure-medium-actuated actuation device according to claim 9, wherein the counterpressure valve arrangement allows a flow of pressure medium in the direction of the actuator and shuts off a flow of pressure medium in the direction away from the actuator up to the predetermined clearance pressure of the pressure medium.

11. Pressure-medium-actuated actuation device according to claim 10, wherein the counterpressure valve arrangement comprises a non-return valve and a cut-in valve connected in parallel to the latter, preferably with an adjustable counterforce.

12. Pressure-medium-actuated actuation device according to claim 1, wherein at least one pressure-limiting valve is provided, which is designed for limiting the pressure in a pressure-medium line section assigned to it, preferably in each pressure-medium line section, to a predetermined pressure-medium limit pressure.

13. Pressure-medium-actuated actuation device according to claim 12, wherein the at least one pressure-limiting valve allows a flow of pressure medium away from the pressure-medium line section assigned to it when the pressure of the pressure medium in this pressure-medium line section exceeds the predetermined pressure-medium limit pressure.

14. Pressure-medium-actuated actuation device according to claim 13, wherein the at least one pressure-limiting valve is arranged in a pressure-medium connecting line connecting the first and the second pressure-medium line section.

15. Pressure-medium-actuated actuation device according to claim 13, wherein in each case a pressure-limiting valve assigned to the first and to the second pressure-medium line section is provided, each pressure-limiting valve allowing a flow of pressure medium away from one pressure-medium line section to the other pressure-medium line section in each case, when the pressure of the pressure medium in the respective pressure-medium line section exceeds the predetermined pressure-medium limit pressure.

16. Pressure-medium-actuated actuation device according to claim 1, wherein the at least one pressure-limiting valve comprises a cut-in valve, preferably with an adjustable counterforce.

17. Pressure-medium-actuated actuation device according to claim 1, wherein at least one pressure-medium line section, preferably all pressure-medium line sections, are connected to a pressure-medium reservoir via a throttle.

18. Pressure-medium-actuated actuation device according to claim 1, wherein the actuator is a piston/cylinder systems.

19. Pressure-medium-actuated actuation device according to claim 1, wherein the actuator is an actuator capable of being driven in a rotational movement.

20. Steering apparatus with a wheel receptacle pivotable about a steering axis, with a force transmission device transmitting a steering force to the wheel receptacle, and with an actuation device according to claim 1, the force transmission device transmitting a force emitted by the actuator of the actuation device to the wheel receptacle in order to pivot the latter about the steering axis.

21. Floor-level conveying vehicle, in particular lift truck, with at least one actuation device according to claim 1.

22. Floor-level conveying vehicle according to claim 21, comprising a steering apparatus according to claim 20.

23. Floor-level conveying vehicle according to claim 22, which comprises a steering regulation device which, by means of at least one steering-angle sensor, detects at least one quantity which represents the instantaneous steering-angle position of at least one steerable wheel, which steering regulation device further, by means of at least one steering-means sensor, detects at least one steering quantity which represents an actuation of a steering means, for example of a steering wheel, which steering regulation device, furthermore, starting from the detected steering quantity, determines a desired steering quantity which represents a wanted steering-angle position of the at least one steerable wheel, and which steering regulation device, finally, activates the pump drive in such a way that the at least one steerable wheel, starting from its instantaneous steering-angle position, is pivoted in the direction of the wanted steering-angle position.
